(19) United States
(12) Patent Application Publication
(10) Pub. No.: US 2013/0126544 A1
(43) Pub. Date: May 23, 2013

(54) HINGES FORMED WITH THERMOPLASTIC MATERIAL

(71) Applicant: Spencer Industries Incorporated, Dale, IN (US)

(72) Inventors: Christopher S. Klem, Saint Meinrad, IN (US); Randy Ray Rhoades, Boonville, IN (US)

(21) Appl. No.: 13/714,495

(22) Filed: Dec. 14, 2012

Related U.S. Application Data
(63) Continuation-in-part of application No. 13/351,604, filed on Jan. 17, 2012.
(60) Provisional application No. 61/434,451, filed on Jan. 20, 2011.
(60) Provisional application No. 61/580,488, filed on Dec. 27, 2011.

(51) Int. Cl. B29C 51/02; B65D 51/00

(52) U.S. Cl. CPC B29C 51/02; B65D 51/00
USPC 220/810; 264/242

(57) ABSTRACT

Disclosed is a lid structure that includes an attachment tab connected to the lid by a living hinge. The attachment tab is configured to be attached to an external structure and the lid defines a ridge and a groove that surrounds the periphery of the lid structure except along the living hinge. Also discloses is a method of manufacturing the lid structure.

### BACKGROUND

Thermoforming is a manufacturing process where a plastic sheet is heated above its glass transition temperature, reformed into a desired shape in a mold, cooled below the glass transition temperature, removed from the mold and then trimmed to create a desired product. Twin sheet thermoforming expands on this process by bonding two separately thermoformed sheets together prior to cooling below the glass transition temperature to create more complex and/or thicker products.

During thermoforming, the edges of the plastic sheet are generally restrained from moving while the inner portion of the sheet is stretched and reshaped by the mold, sometimes with a differential pressure (e.g. negative vacuum pressure on the mold side of the sheet and/or positive pressure on the opposite side) pushing the sheet against the mold. This leaves excess material around the periphery of the molded part that is generally removed to create the final desired product. This excess material is known as offal. Offal removal can be accomplished by placing the molded product, including offal, in a jig configured to secure the product while the offal is removed by die trimming, in mold trimming, CNC cutting or machining.

### BRIEF DESCRIPTION OF THE DRAWINGS

FIG. 1 is a front perspective view of a sectional door incorporating multiple panel sections.

FIG. 2 is a rear perspective view of the FIG. 1 sectional door.

FIG. 3 is a top view of a panel section of the FIG. 1 sectional door.

FIG. 4 is a side elevational view of the FIG. 3 panel section.

FIG. 5 is a front elevational view of the FIG. 3 panel section.

FIG. 6 is a bottom view of the FIG. 3 panel section.

FIG. 7 is a side cross sectional view of two panel sections joined together.

FIG. 8 is an exploded side cross sectional view of FIG. 7 taken within circle 8.

FIG. 9 is an enlarged cross sectional view of FIG. 7 taken inside circle 9.

FIG. 10A is a partial view, which in combination with FIG. 10B, shows a process diagram detailing a method of thermoforming a panel section.

FIG. 10B is a partial view continued from FIG. 10A showing a second portion of the process diagram detailing the method of thermoforming a panel section.

FIG. 11 is a side cross sectional view of a panel section in an as molded configuration.

FIG. 12 is a side view of the FIG. 11 configuration.

FIG. 13 is a partial bottom view of the FIG. 6 panel section shown in an intermediate condition with offal still attached.

FIG. 14 is a partial side view of FIG. 4 taken inside circle 14.

FIG. 15 is a partial cross sectional view of FIG. 11 taken inside circle 15.

FIG. 16 is a partial cross sectional view of FIG. 11 taken inside circle 16.

FIG. 17 is a side cross sectional view of two panel sections joined together showing flex in the living hinges during opening or closing of the sectional door.

FIG. 18 is a perspective view of a toolbox lid.

FIG. 19 is a top view of the FIG. 18 toolbox lid.

FIG. 20 is a back side elevational view of the FIG. 18 toolbox lid.

FIG. 21 is a bottom plan view of the FIG. 18 toolbox lid.

FIG. 22 is a front elevational view of the FIG. 18 toolbox lid.

FIG. 23 is a right side elevational view of the FIG. 18 toolbox lid.

FIG. 24 is a top plan view of the FIG. 18 toolbox lid in an intermediate state of manufacture prior to removing the molding offal.

FIG. 25 is a partial cross sectional view of FIG. 23 taken inside circle 25.

FIG. 26 is a perspective view of a box incorporating the FIG. 18 toolbox lid.

FIG. 27 is a partial perspective view of the FIG. 26 box taken inside circle 27.

FIG. 28 is a perspective view of the FIG. 26 box showing the lid in an open position.

FIG. 29 is an assembly view of the FIG. 26 box.

FIG. 30 is a cross sectional view of the FIG. 26 box.

### DETAILED DESCRIPTION

Reference will now be made to certain embodiments and specific language will be used to describe the same. It will nevertheless be understood that no limitation of the scope of this disclosure and the claims are thereby intended, such alterations, further modifications and further applications of the principles described herein being contemplated as would normally occur to one skilled in the art to which this disclosure relates. In several figures, where there are the same or similar elements, those elements are designated with the same or similar reference numerals.

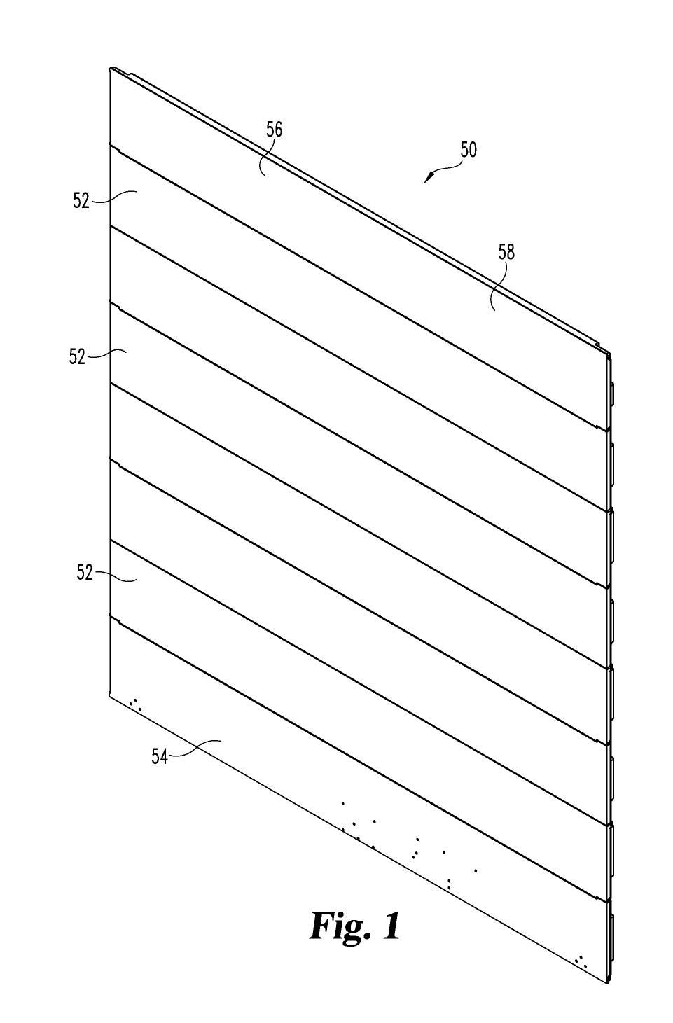

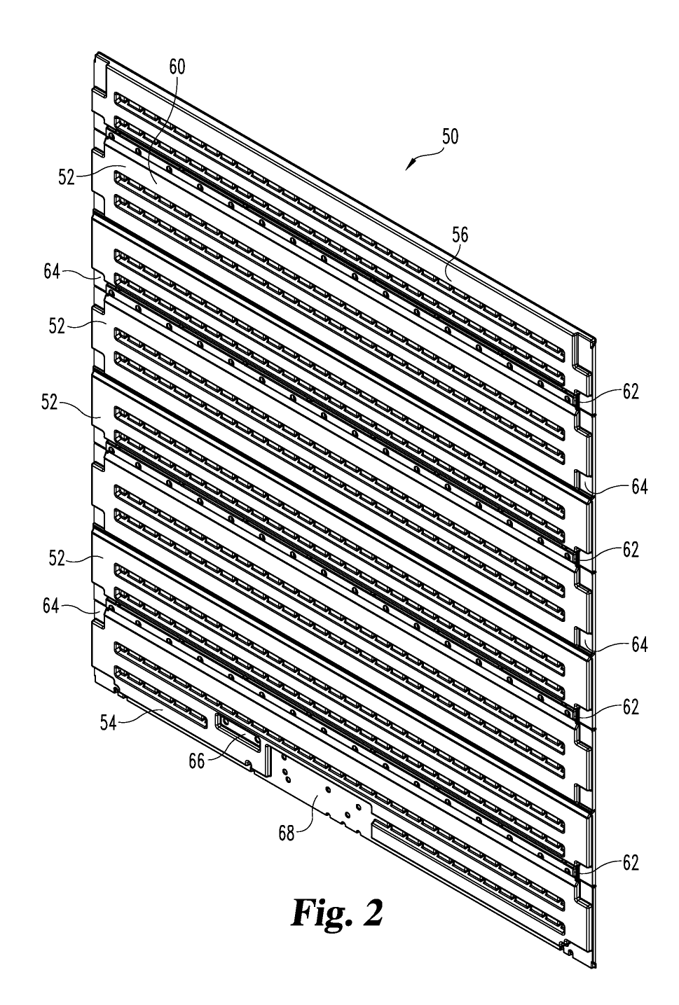

Referring to FIGS. 1 and 2, a sectional door 50 is illustrated. Sectional door 50 includes a plurality of panel sections 52, bottom panel section 54 and top panel section 56 attached together forming sectional door 50. In this context, sectional door refers to a door that includes separate hinged panels that slide along a slide track or other guide to open and close the door. Common examples include overhead garage doors and overhead vehicle trailer doors. Sectional door 50 illustrated in FIGS. 1 and 2 is configured as a vehicle trailer but the door described herein can be utilized for other desired door applications. Similarly, while overhead type doors are explicitly described herein, other sectional door configurations are intended to be covered, including section doors configured for side or bottom storage when opened.

Panel sections 52, 54 and 56 are coupled together by attachment tab 62 that is a part of panel sections 52 and 54. Details of this attachment are discussed below.

Each of panel sections 52, 54 and 56 include recesses 64 on the right and left side as shown in FIG. 2. Recesses 64 may be configured to accept attachment hardware to couple sectional door 50 to guides or rollers to be used in conjunction with a track or other guide mechanism to hold sectional door 50 in position and permit opening and closing sectional door 50 as is known in the art. Bottom panel section 54 also includes recesses 66 and 68. Recess 66, in the illustrated embodiment, is configured to attach a handle for opening and closing sectional door 50 while recess 68 is configured to accept a latching mechanism to secure sectional door 50 in a closed position and to provide an optional locking mechanism. The particular configuration of recesses 64, 66 and 68 is dependent upon the desired hardware to be attached to sectional door 50 and can be varied or omitted as appropriate.

Section door 50 includes outer surface 58 as shown in FIG. 1 and inner surface 60 as shown in FIG. 2. The illustrated outer surface 58 is substantially flat and is adapted to receive painting, printing and/or signage for use in conjunction with a vehicle.

The following includes a detailed description of panel section 52. It should be understood that many of the features described below with regard to panel section 52 are equally applicable to bottom panel section 54 and top panel section 56. Bottom panel section 54 and top panel section 56 are not otherwise described.

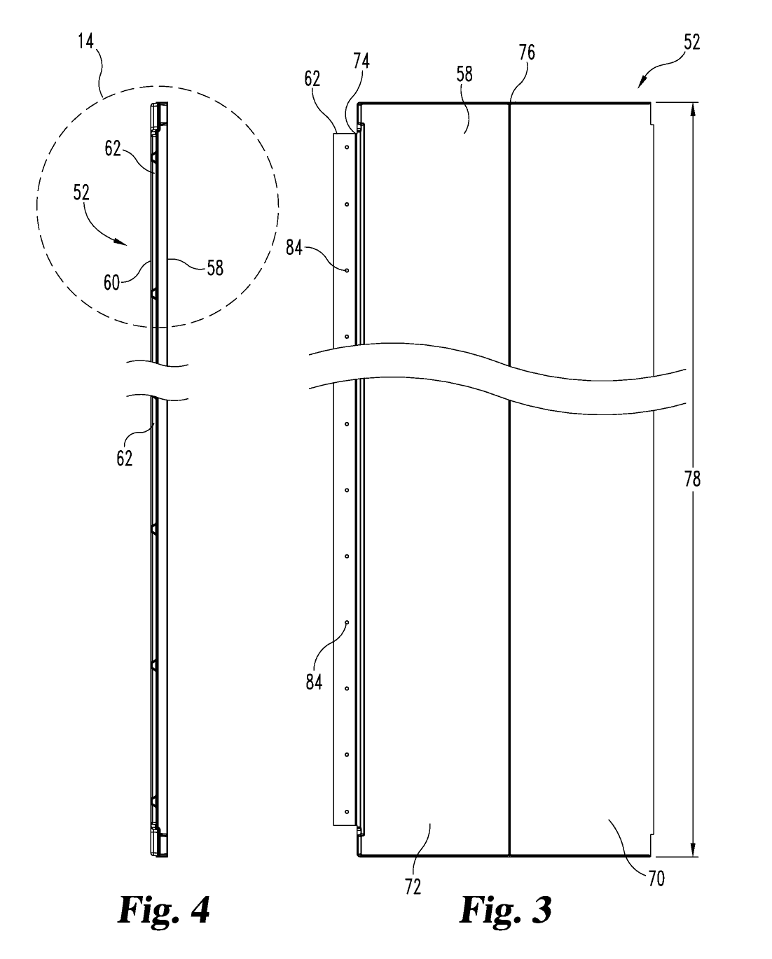

Referring to FIGS. 3-6, panel section 52 is illustrated. Panel section 52 includes attachment tab 62, panel portions 70 and 72, living hinges 74 and 76, outer surface 58, inner surface 60 and ribs 80. Living hinge 74 delimits attachment tab 62 and panel portion 72. Living hinge 76 delimits panel portions 70 and 72. As described below, attachment tab 62, panel portions 70 and 72 and living hinges 74 and 76 are integrally formed as a monolithic structure. The top and bottom of attachment tab 62 and living hinge 74 are defined by edge 88. In this context, “living hinge” refers to a thinned, flexible plastic hinge, that both joins two parts together and permits those parts to bend along the line of the hinge. Panel portion 52 is illustrated in a broken configuration to permit additional details to be shown. It should be understood that panel portion 52 has overall width 78 that is configurable to fit a desired door width. As discussed above, outer surface 58 of panel section 52 includes a substantially flat surface conversely inner surface 60 of panel section 52 includes a plurality of ribs 80 that are optionally included for stiffness and strength as further discussed below.

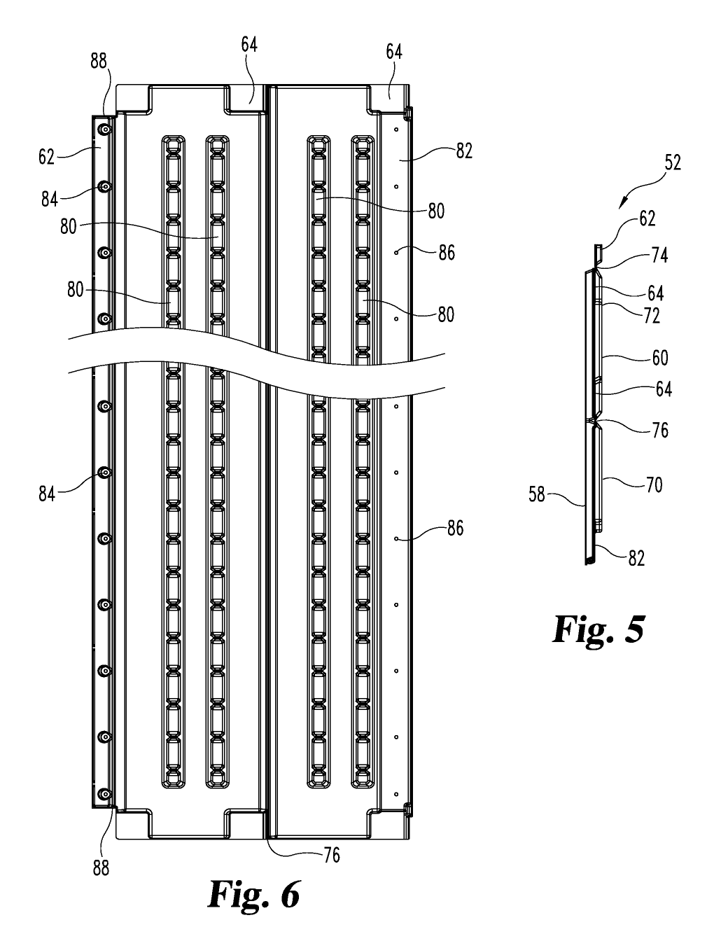

As best shown in FIG. 6, panel portion 70 defines receiver portion 82 that is configured to receive attachment tab 62. Attachment tab 62 includes a plurality of fastener holes 84 spaced along its length while receiver portion 82 includes a plurality of fastener holes 86 spaced along its length mirroring the positions of fastener holes 84. Comparison of FIGS. 3 and 6 show that fastener holes 84 are through holes while fastener holes 86 only pass through inner surface 60 but do not penetrate outer surface 58. This is discussed in additional detail below.

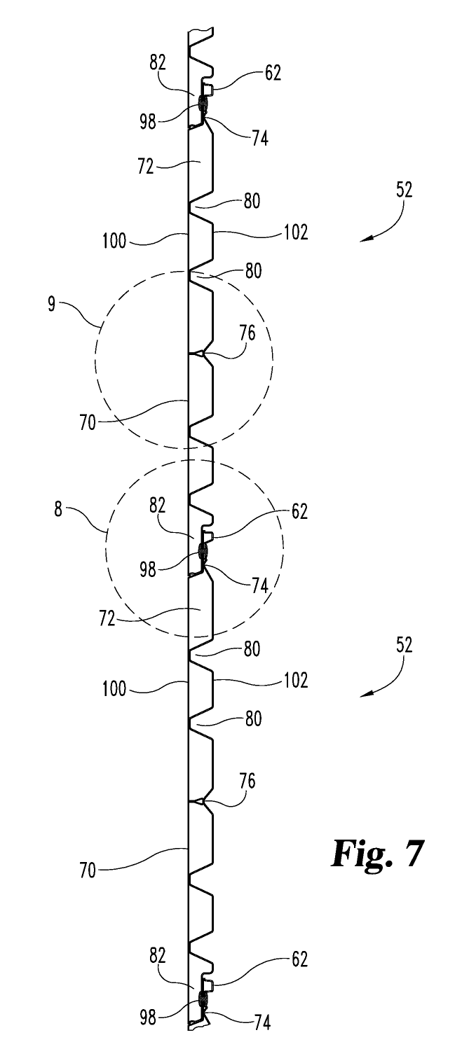

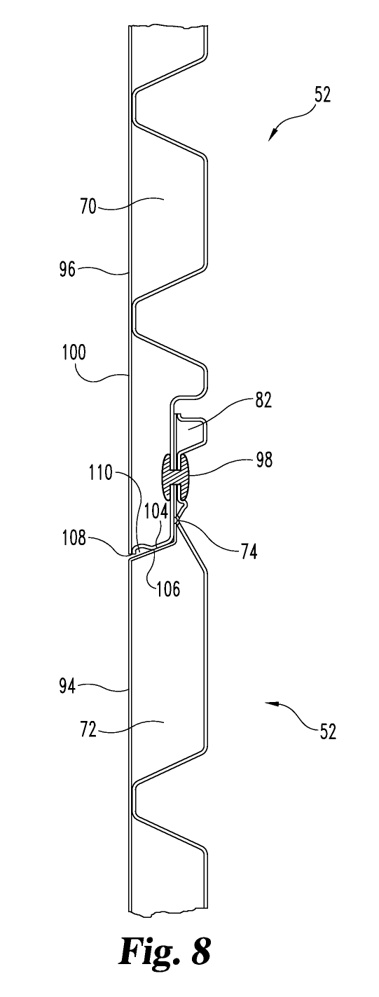

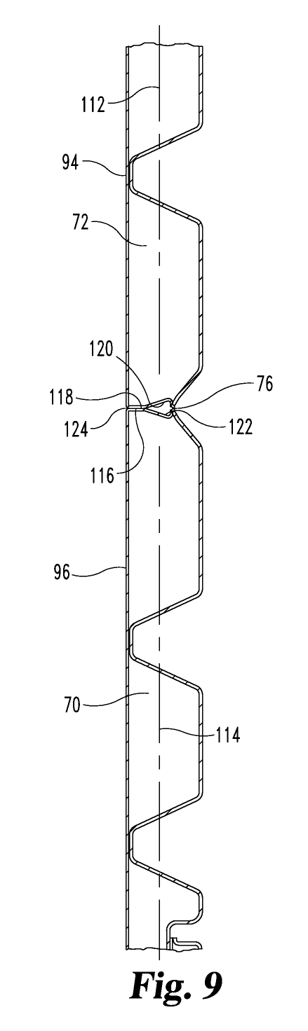

Referring now to FIGS. 7-9, two panel sections 52 are illustrated coupled together by fastener 98. While FIGS. 7 and 9 illustrate a cross section and thus show only a single fastener 98, it should be understood that a plurality of fasteners 98 are utilized to fasten panel sections 52 together via fastener holes 84 and 86 as discussed above. As previously discussed, each panel section 52 includes panel portions 70 and 72 separated by living hinge 76 and living hinge 74 separates attachment tab 62 from panel portion 70.

Outer surface 58 includes outer surface 94 on panel portion 70 and outer surface 96 on panel portion 72. In the illustrated cross section, panel portion 52 includes outer sheet 100, inner sheet 102, and weld seam 108. Panel portion 70 defines longitudinal axis 112 and panel portion 72 defines longitudinal axis 114, outer sheet 100 defines bearing surfaces 116 and 118 and recesses 120 and 122. Inner sheet 102 defines bearing surfaces 104 and 106 and recess 110.

When assembled as sectional door 50, panel sections 52 are arranged in an abutting relationship with bearing surface 104 directly abutting and bearing against bearing surface 106. When aligned and arranged in this way, fastener holes 84 and 86 are configured to align permitting placement of fastener 98. As discussed above, fastener 98 can be configured to pass through attachment tab 62 and only inner sheet 102 to secure the two panel sections 52 together without affecting outer sheet 100.

In the illustrated embodiment, fastener 98 is a rivet type fastener that has a blind side expander that is insertable through a hole and then later expanded to complete the fastener, as is well known in the art. Other embodiments (not illustrated) use other types of fasteners as desired. For example, fastener hole 86 could include an integral nut body, and fastener 98 could include a threaded bolt. In yet other embodiments, attached tab 62 could be joined to receiver portion without a mechanical fastener by welding or adhesive. In yet other embodiments (not illustrated), fastener 98 could pass through outer sheet 100. Any desired method may be used to join panels together.

As discussed in greater detail below, in the illustrated embodiment, outer sheet 100 and inner sheet 102 are thermoformed together and include welded seam 108. Welded seam 108 is separated from bearing surface 106 by recess 110 with receiver portion 82 and weld seam 108 configured so that welded seam 108 does not contact bearing surface 104 (or any other part of the attached panel section 52).

Referring to FIG. 9, an enlarged view proximate to living hinge 76 is illustrated. Bearing surfaces 116 and 118 are configured to abut and bear against each other when longitudinal axes 112 and 114 are aligned as illustrated. Panel portions 70 and 72 also define recesses 120 and 122 that separate bearing surfaces 116 and 118 from living hinge 76. Recess 120 and 122 are configured to never contact each other.

Bearing surfaces 104, 106, 116 and 118 are configured to support and transfer compressive loads across the illustrated abutting surfaces.

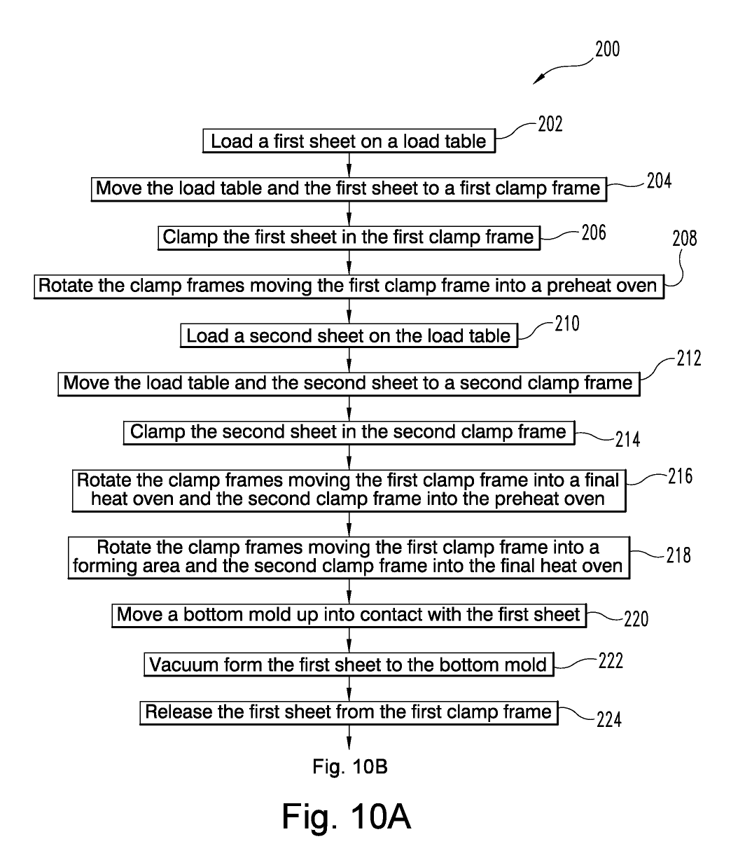

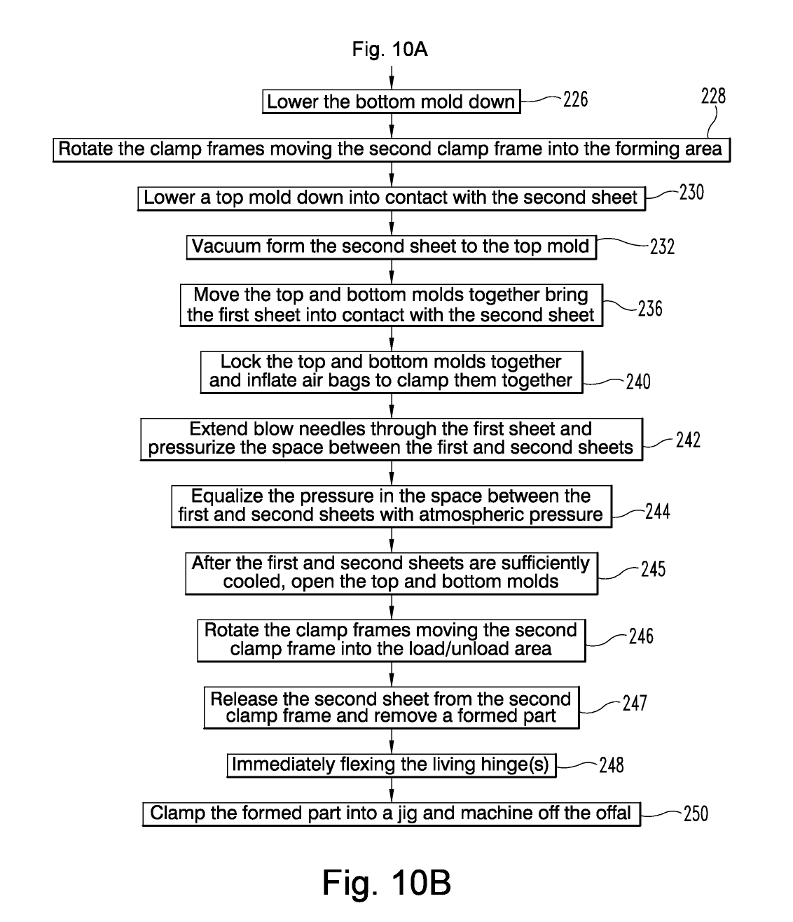

Referring now to FIG. 10, process 200 is illustrated. Process 200 details many process steps that could be used to thermoform panel section 52. However, process 200 is not all-inclusive and many additional steps would be apparent to a person of ordinary skill in the art. The steps described in process 200 generally involve a multi-station thermoforming machine that includes at least four stations that move plastic sheets between the four stations by a set of clamp frames that rotate between the four positions. The four positions include a load/unload station, a first preheat oven, a second final heat oven and a molding position where thermoforming takes place. The manufacturing process described herein is related to making a single unit. It should be understood that this manufacturing process is intended to be used as a continuous process where the actions described for each station repeatedly reoccur, facilitating continuous production of manufactured parts. Furthermore, while a multi-station thermoforming machine is described, process 200 is intended to be adapted to whatever type of thermoforming machine is desired with appropriate modifications to account for known differences. Similarly, process 200 is intended to be adaptable by persons skilled in the art to other types of multi-station thermoforming machines that are not explicitly described, for example, thermoforming machines that clamp two sheets in a single clamp frame, as known in the art.

In any event, process 200 begins with step 202. In step 202 inner sheet 102 is loaded onto a load table in the load/unload station. In step 204 the load table is moved up to bring inner sheet 102 into the boundaries of a first clamp frame and in step 206 the clamp frame clamps inner sheet 102 around the periphery to secure inner sheet 102 within the clamp frame. The load table is then lowered back down to the load position.

Process 200 continues with step 208 where the clamp frames are rotated moving the first clamp frame into the preheat oven and moving a second clamp frame into position in the load/unload station and in step 210. In step 210 outer sheet 100 is loaded onto the load table and in step 212 the load table is moved up, positioning outer sheet 100 within the second clamp frame. In step 214, outer sheet 100 is clamped within the second clamp frame and the load table is lowered.

Process 200 continues with step 216 where the clamp frames are rotated again, moving the first clamp frame into the final heat oven and the second clamp frame into the preheat oven. This is followed by step 218 where the clamp frames are rotated yet again moving the first clamp frame into the forming area and the second clamp frame into the final heat oven. By this time, inner sheet 102 should be heated above its glass transition temperature. Immediately after moving the first clamp frame in the forming area, a bottom mold is moved into contact with the first sheet in step 220. In step 222, a vacuum assist is utilized to form inner sheet 102 to the bottom mold. After inner sheet 102 is formed to the bottom mold then inner sheet 102 is released from the first clamp frame in step 224 and the bottom mold and inner sheet 102 are lowered down in step 226.

This is followed by step 228 where the clamp frames are rotated again, moving the second clamp frame into the forming area where the top mold is lowered down into contact with outer sheet 100 in step 230 and then subsequently vacuumed formed to conform to the shape of the top mold in step 232. Outer sheet 100 continues to be retained in the second clamp after being formed to conform to the top mold.

In step 236, the top and bottom molds are brought together bringing portions of the inner sheet 102 into contact with the outer sheet 100. This is followed by step 240 where the top and bottom molds are locked together with bayonets and air bags are inflated to create a tight seal and clamp the top and bottom molds together. Next in step 242, blow needles are extended through inner sheet 102 and pressurized as is applied through the blow needles to the spaces between inner sheet 102 and outer sheet 100. This could include slightly pressurizing the space and also removing hot air from the space by opening some of the needles to atmosphere while pressurizing other vents. This could also include sequentially applying pressure through the needles at high and low pressure while some of the needles are open to atmosphere. Generally, pressurized air is injected in approximately half of the needles while the remaining needles are vented to atmosphere. This creates a small positive pressure and an air flow that helps remove hot air captured between outer sheet 100 and inner sheet 102. In other instances, high pressure air is injected to assist in forming the part against the molds for a portion of step 242.

This is followed by equalizing the pressure in the space between the first and second sheets with atmospheric pressure through the needles in step 244 to prevent ballooning or collapse of the part due to differential pressure between the interior space and the atmosphere. This also allows any heat gradients in the space between the sheets to equalize. The blow needles are then retracted from inner sheet 102. Note that while process 200 describes the blow needles only extending through inner sheet 102, the blow needles can extend through any surface desired, including outer sheet 100.

After sheets 100 and 102 are sufficiently cooled, bonded and welded together, the top and bottom molds are opened in step 245. This is followed by step 246 where the clamp frames are rotated, moving the second clamp frame into the load/unload station where, in step 247, the second clamp frame is opened, releasing the second sheet and formed panel section 52 is removed. Immediately after removing the formed panel section 52, living hinge(s) 74 and 76 are flexed in step 248. To facilitate this, edges 88 may optionally be die cut between the top and bottom molds in step 240. After the formed part is removed it is clamped in a jig and the offal is machined off in step 250, completing panel section 52.

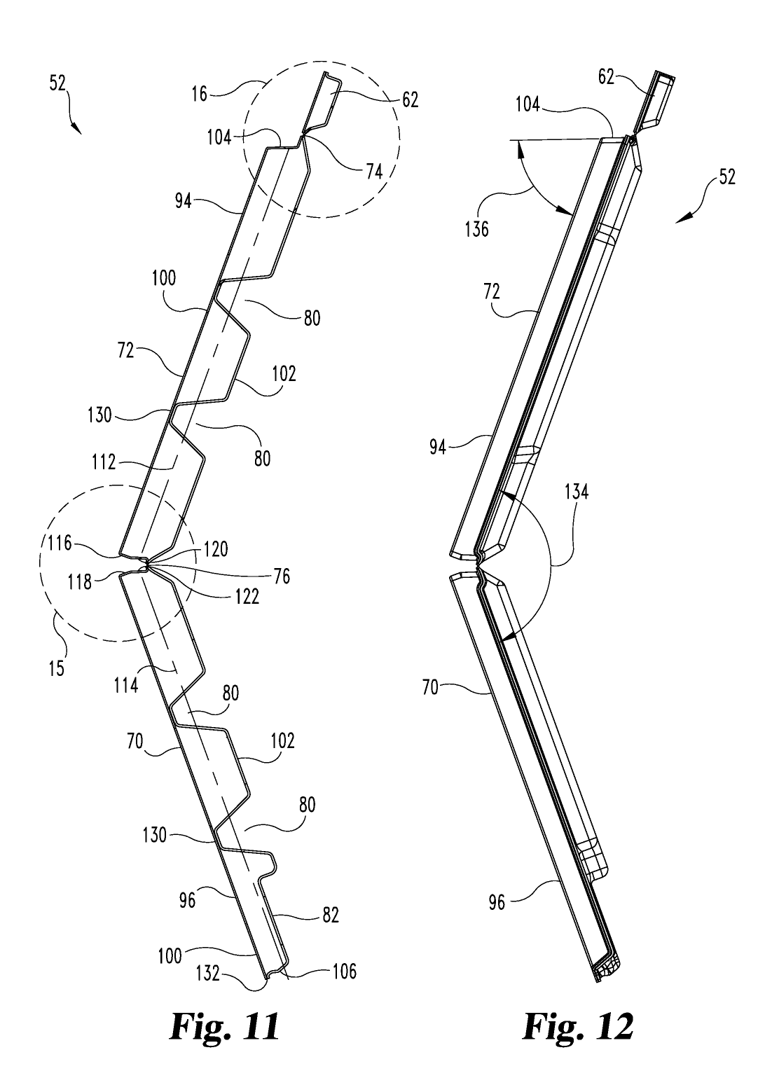

Referring now to FIGS. 11 and 12, panel section 52 is illustrated as oriented during thermoforming in process 200. (Note that FIGS. 11 and 12 are rotated 90 degrees to better fit on the page.) In one manufacturing orientation, the illustrated panel section 52 would be orient in a “V” configuration, with living hinge 76 positioned below living hinge 74.

FIG. 11 illustrates a cross sectional view of panel section 52 showing melt bonds 130 and 132 between outer sheet 100 and inner sheet 102. Melt bonds 130 are positioned at the top of ribs 80 and represents an optional technique to stiffening panel section 52 by increasing the points of contact between outer sheet 100 and inner sheet 102 and by providing increased web structures between outer sheet 100 and inner sheet 102. Melt bond 132 is on the outer edge near receiver portion 82 and corresponds to weld seam 108 prior to machining.

Living hinges 74 and 76 also represent a point of melt bonding between outer sheet 100 and inner sheet 102. However, the relative force applied to the areas of living hinges 74 and 76 are substantially higher than melt bonds 130 and 132 to facilitate forming living hinges 74 and 76. In process 200 this is accomplished by including a movable insert in the top and/or bottom molds that's position can be adjusted along the length of living hinges 74 and 76, for example by shimming the movable insert. This permits control of the thickness of living hinges 74 and 76.

As shown in FIG. 11, longitudinal axis 112 and 114 of panel portions 70 and 72 are angled apart by mold angle 134 during thermoforming. In the illustrated embodiment, mold angle 134 is equal to approximately 140°. In other embodiments (not illustrated) mold angle 134 could be between approximately 130° and 150°.

As shown in FIG. 12, bearing surface 104 is angled from longitudinal access 112 by angle 136. In the illustrated embodiment, angle 136 is equal to approximately 70°. In other embodiments, angle 136 may be equal to approximately half of mold angle 134.

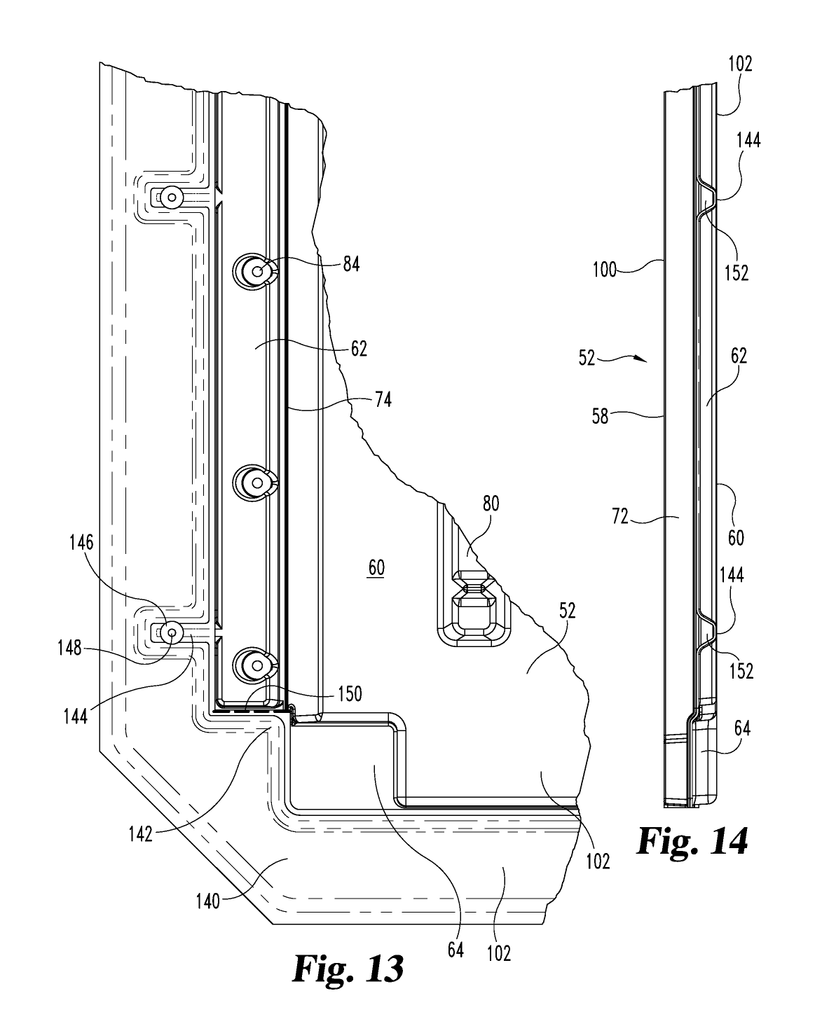

Referring to FIG. 13, a partial bottom view of panel section 52 is illustrated showing panel section 52 in an incomplete state as it may appear after step 246 in procedure 200 but before steps 248 or 250. As illustrated in FIG. 13, panel section 52 includes offal 140, weld seam 142, vent 144, receptor 146, needle hole 148 and die cut score line 150. Offal 140 includes the portions of inner sheet 102 (and outer sheet 100 which is not visible in this view but is located on the opposite side) that is gripped by the clamp frames and which provide a reservoir of plastic material for draw down during molding. Offal 140 includes most of weld seam 142 that defines the outer periphery of panel section 52. Vent 144 and receptor 146 are molded structures that extend into the offal area to provide venting of the interior spaces defined by attachment tab 62. Receptor 146 is configured to receive a blow needle in step 242 of procedure 200. Vent 144 provides an internal passageway between receptor 146 and the interior space between outer sheet 100 and inner sheet 102 in attachment tab 62. Needle hole 148 depicts the hole where the blow needle extended through inner sheet 102.

Also shown in FIG. 13 is die cut score line 150 along the bottom of attachment tab 62 and living hinge 74. Die cut score line 150 is located in weld seam 142 and may represent either a thinned portion of weld seam 142 or a through cut. Panel section 52 shown in FIG. 13 is machined in step 250 of procedure 200 to the final configuration illustrated in FIGS. 3-6 by machining or cutting off offal 140 along weld seam 142. Vent 144 and interceptor 146 are machined or cut off and removed with the offal.

Referring to FIG. 14, partial side view of panel section 52 is illustrated mirroring the portion of panel section 52 shown in FIG. 13. As shown in FIG. 14, machining or cutting vent 144 off leaves passage 152 through the sidewall of attachment tab 62.

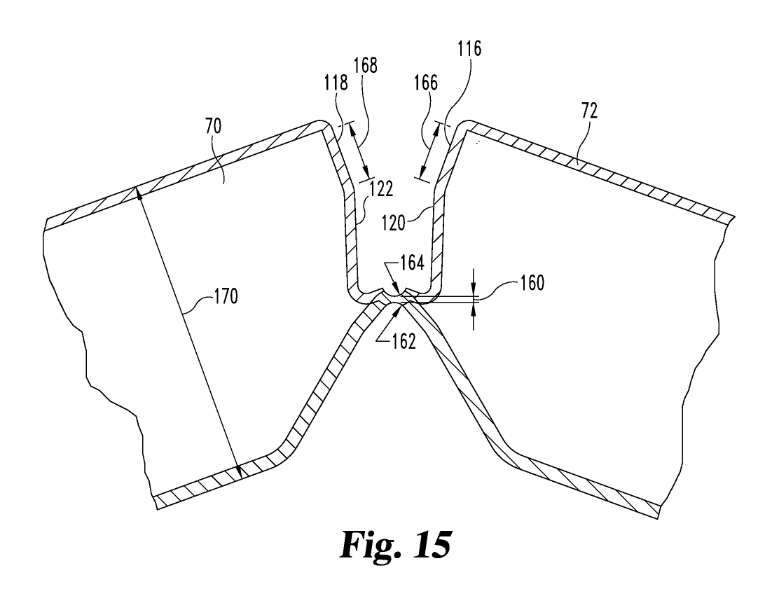

Referring to FIG. 15, an enlarged view of the FIG. 11 cross section of panel section 52 proximate to living hinge 76 is illustrated. As shown in FIG. 15, living hinge 76 includes thickness 160, bottom radius 162, top radius 164, with bearing surface 116 having a length 166 and bearing surface 118 having length 168. In the illustrated embodiment, thickness 160 is approximately equal to 0.030 inches. In other embodiments, thickness 160 can vary between approximately 0.028 and 0.040 inches thick. In the illustrated embodiment, radiuses 162 and 164 are both equal to approximately 0.063 inches and lengths 166 and 168 are both equal to approximately 0.29 inches. In other embodiments, lengths 166 and 168 can vary between approximately 0.10 and 0.30 inches. In the illustrated embodiment, panel width 170 is equal to approximately 1.5 inches.

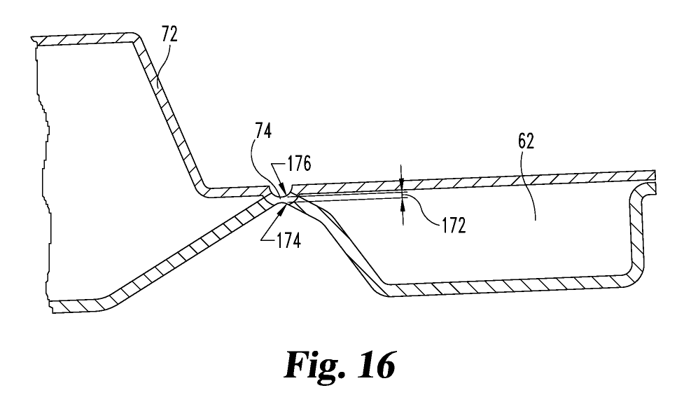

Referring to FIG. 16, an enlarged view of FIG. 11 proximate to living hinge 74 is illustrated showing living hinge thickness 172, top radius 176 and bottom radius 174. In the illustrated embodiment, thickness 172 is approximately equal to 0.030 inches. In other embodiments, thickness 172 can vary between approximately 0.028 and 0.040 inches thick. In the illustrated embodiment, radiuses 174 and 176 are both equal to approximately 0.063.

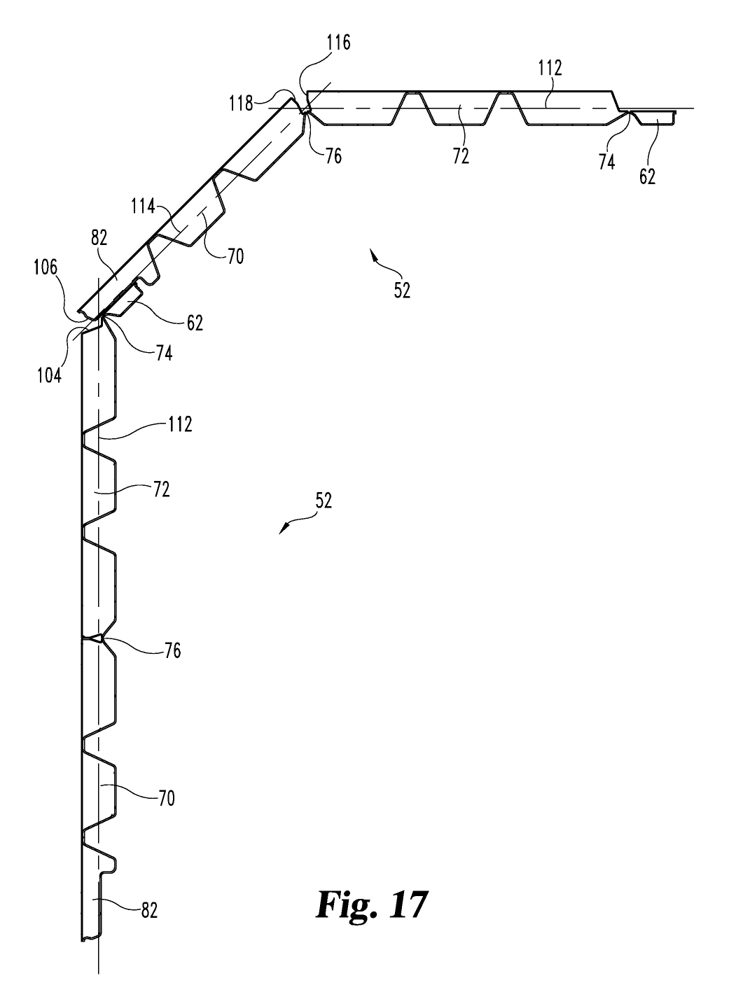

Referring to FIG. 17, a cross sectional view of two panel sections 52 is illustrated with panel sections 52 joined together at attachment tab 62 and receiver portion 82 as discussed above. The upper panel section 52 is shown flexed through an approximate 90° bend as would be typical when opening or closing most sectional doors. In particular, in the upper panel section 52, longitudinal axes 112 and 114 are angled apart by approximately 135° while longitudinal axis 114 on the upper panel section 52 and longitudinal axis 112 on the lower panel section 52 are also angled apart by approximately 135°. Bearing surfaces 116 and 118 on the upper panel section do not bear against each other. Similarly bearing surface 106 on the upper panel section 52 does not bear against bearing surface 104 on the lower panel section 52 (as compared to what is illustrated in FIGS. 7-9).

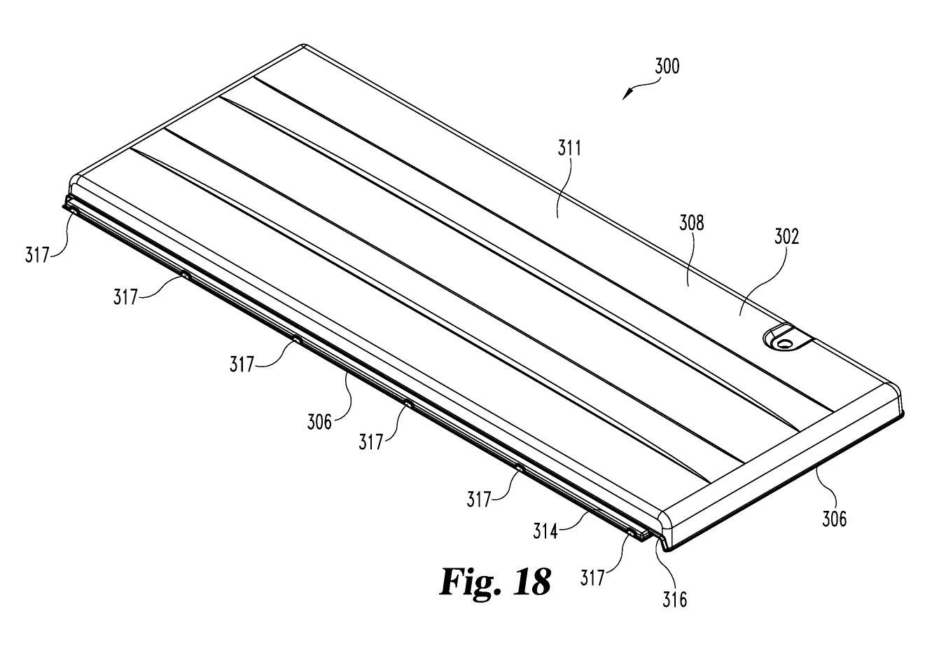

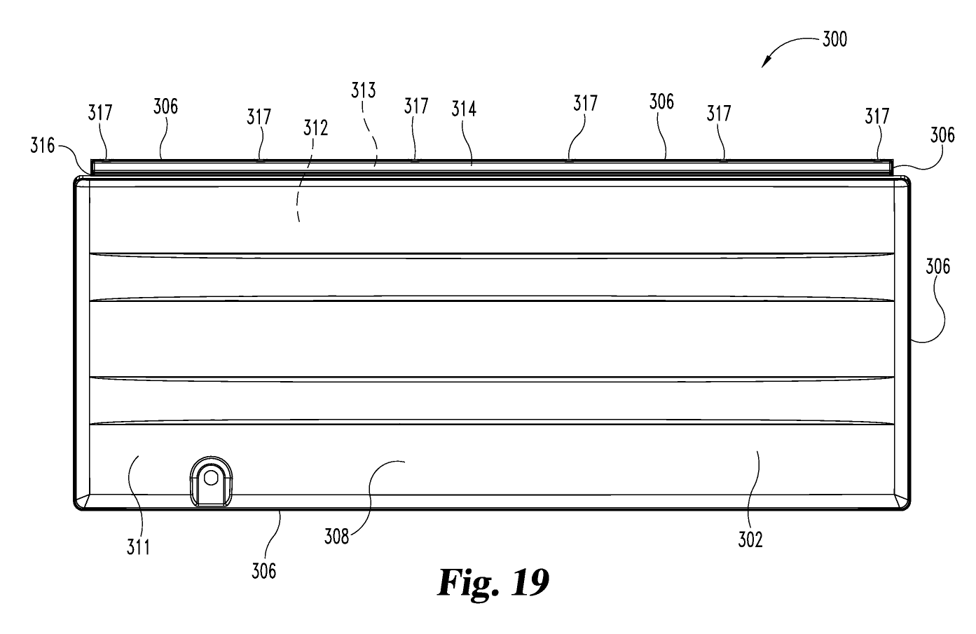

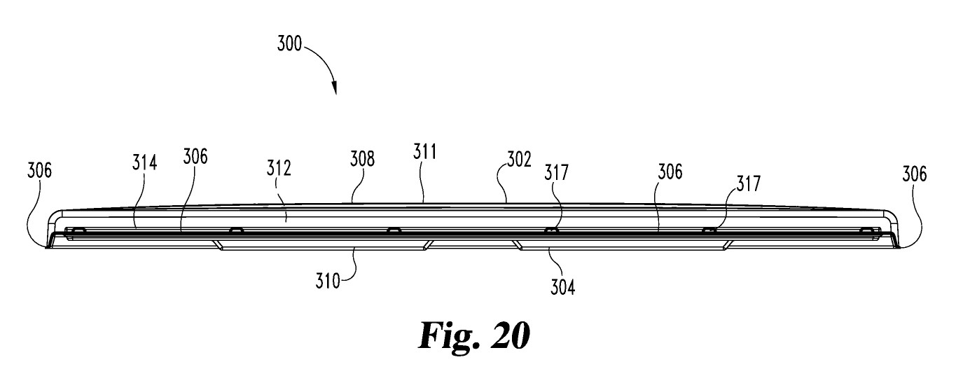

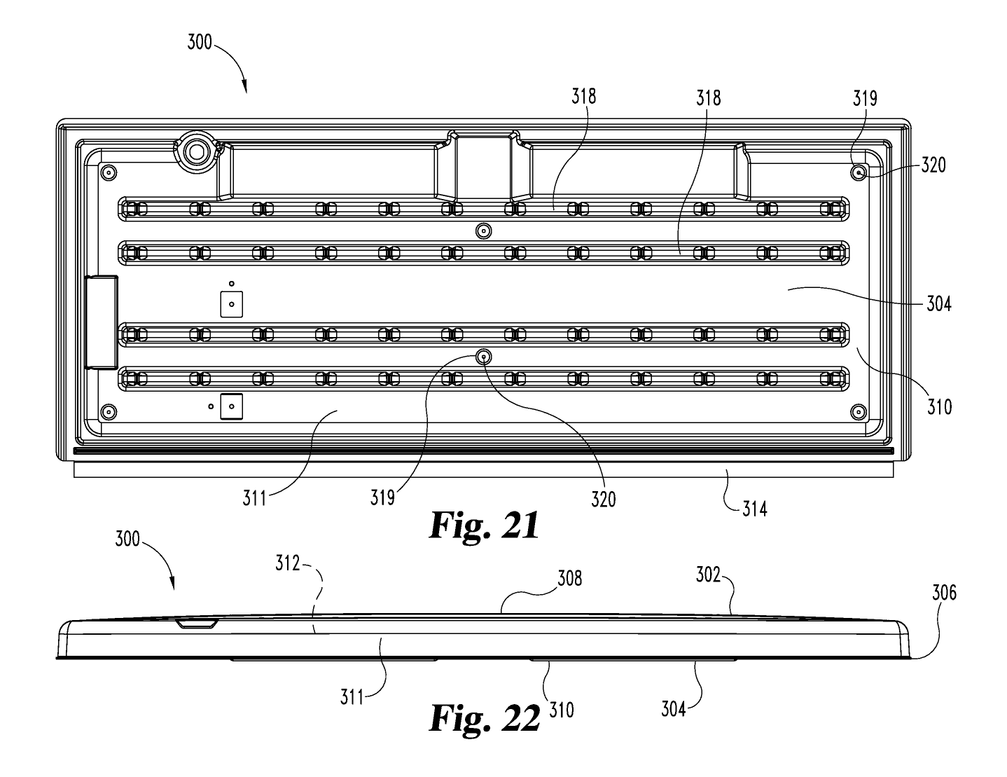

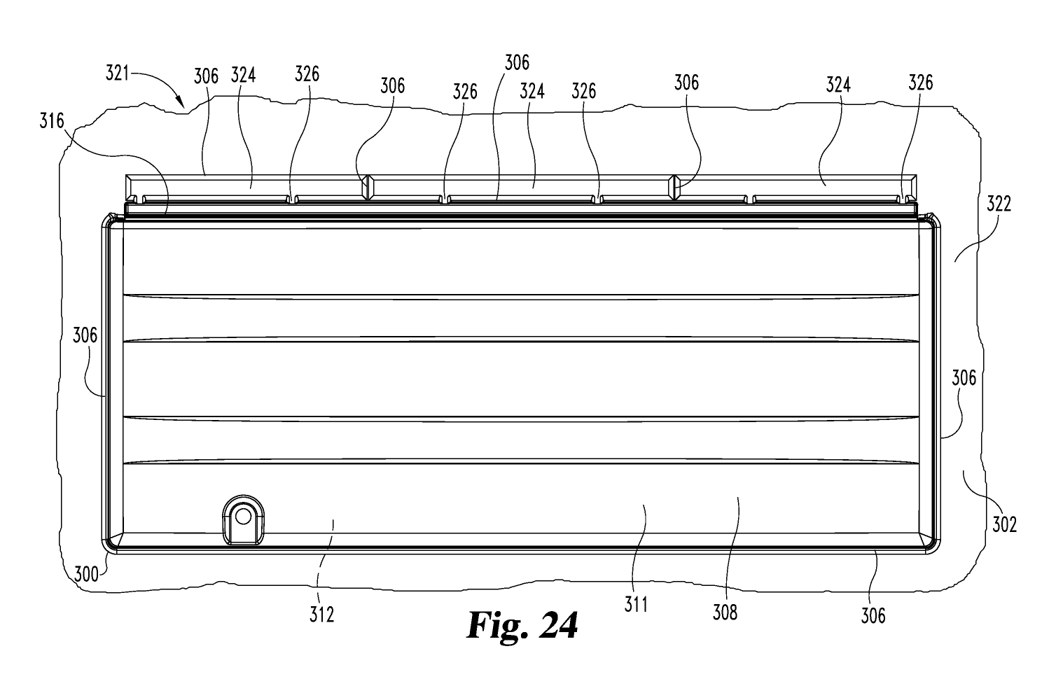

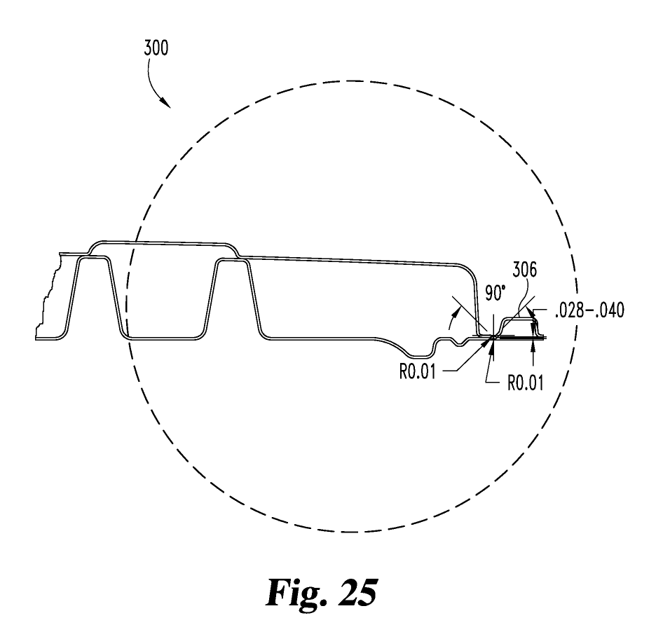

Referring to FIGS. 18-23, lid 300 is illustrated. Lid 300 is a toolbox lid for a truck toolbox. Lid 300 is thermoformed from plastic sheets 302 and 304 bonded together along bond flange 306. Lid 300 includes top surface 308, bottom surface 310, body 311, tab 314 which is separated from body 311 by living hinge 316. Body 311 has an internal cavity 312 and tab 314 has internal cavity 313. Internal cavities 312 and 313 represent the space between sheets 302 and 304 when they are thermoformed together. Tab 314 also includes a plurality of vents 317. As discussed in greater detail below, vents 317 are molded structures that extend into the offal area (removed in FIGS. 18-23, shown in FIG. 24) to vent internal cavity 313.

As best illustrated in FIG. 21, bottom surface 310 includes a plurality of ribs 318 that are optionally included for stiffness and strength. Ribs 318 may provide web structures across bottom surface 310 that may serve to increase the overall strength and stiffness of bottom surface 310 and body 311.

Also illustrated in FIG. 21 are a plurality of blow needle recesses 319 and holes 320. Holes 320 depict the hole left when a blow needle is extended through plastic sheet 304 during a thermoforming process to vent and/or move a vent transfer fluid through internal cavity 312.

Referring now to FIG. 24, lid 300 is illustrated in an intermediate manufacturing condition prior to removing the molding offal. Unfinished lid 321 includes offal 322, chamber 324 and vents 326. Chamber 324 is defined in the offal region of plastic sheets 302 and 304 and is bound by bond flange 306. Vent 326 is also defined by plastic sheets 302 and 304. Vent 326 connects the interior space of chamber 324 with internal cavity 313 in tab 314. Chamber 324 is configured and arranged to receive one or more blow needles during the molding process. The blow needles can then be used to vent internal cavity 313 and/or move a vent transfer fluid, such as air, through vents 326 and internal cavity 313 to aide in cooling plastic sheets 302 and 304 defining tab 114.

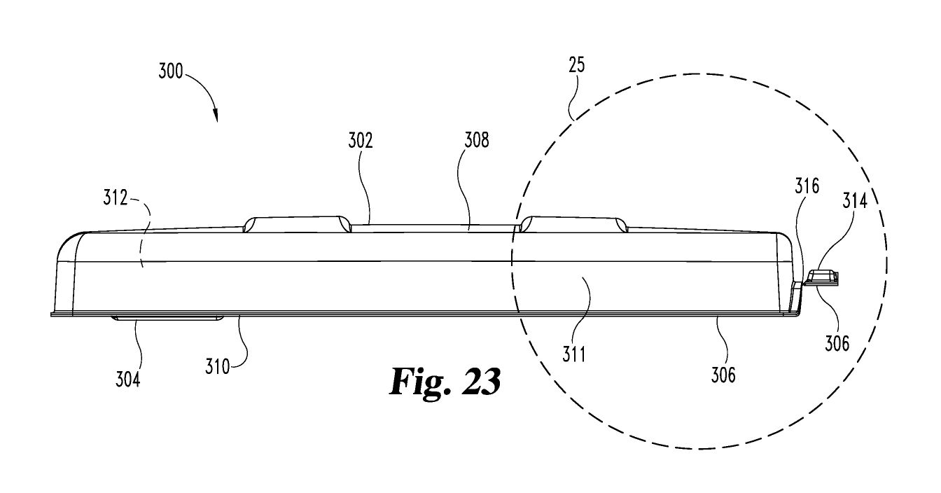

As best shown in FIG. 23, tab 314 is dimensionally configured too small to reliably insert blow needles into internal cavity 313. Chamber 324 provides a structure that is sufficiently large to receive a blow needle and vents 326 fluidly connect the two. In one embodiment, an individual chamber 324 can receive blow needles proximate to each vent 326. In one embodiment, some blow needles can provide a supply of heat transfer fluid while the remaining blow needles can withdraw the heat transfer fluid to provide a flow through internal cavity 313. In other embodiments, the central chamber 324 illustrated in FIG. 24 could receive one set of blow needles that supply heat transfer fluid while the two chambers 324 positioned on the outside could receive blow needles to withdraw the heat transfer fluid to provide a flow through internal cavity 313.

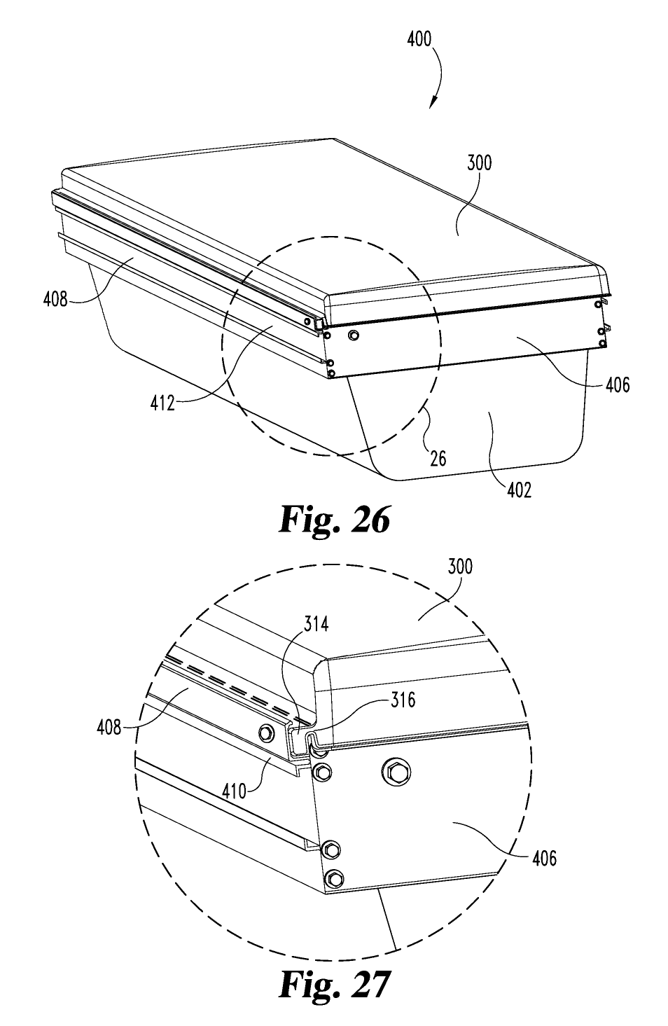

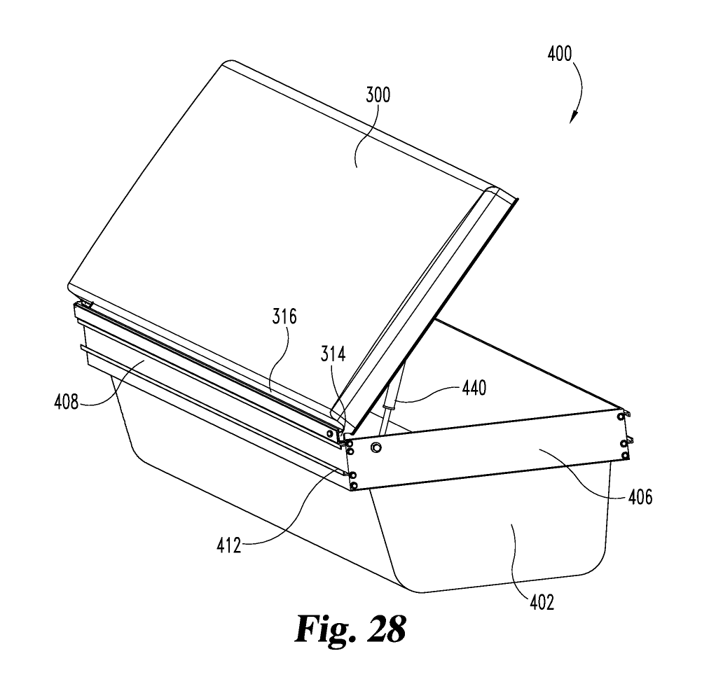

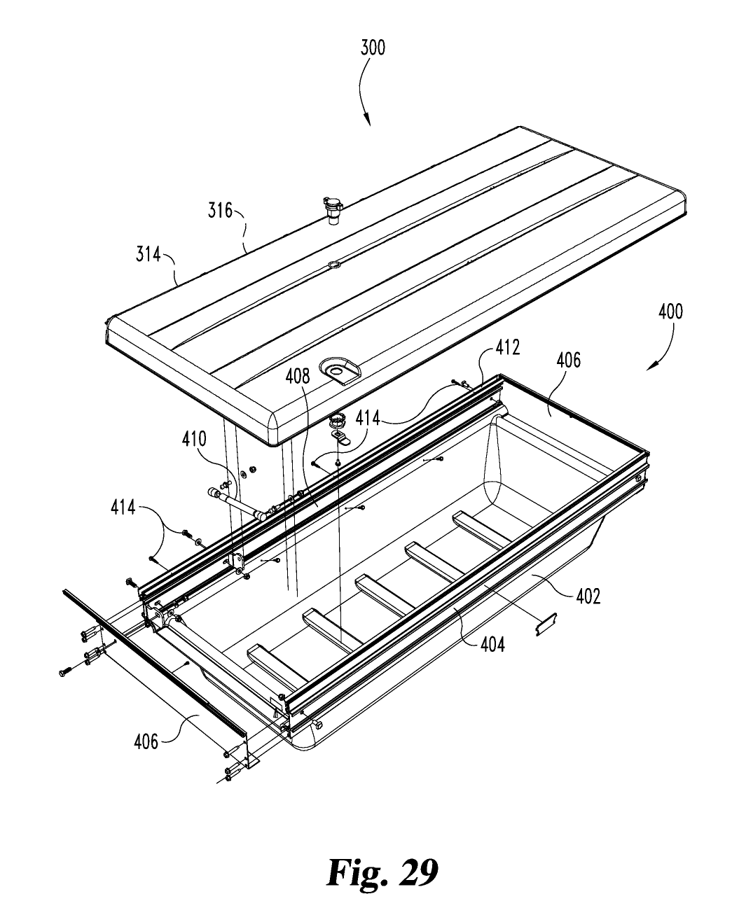

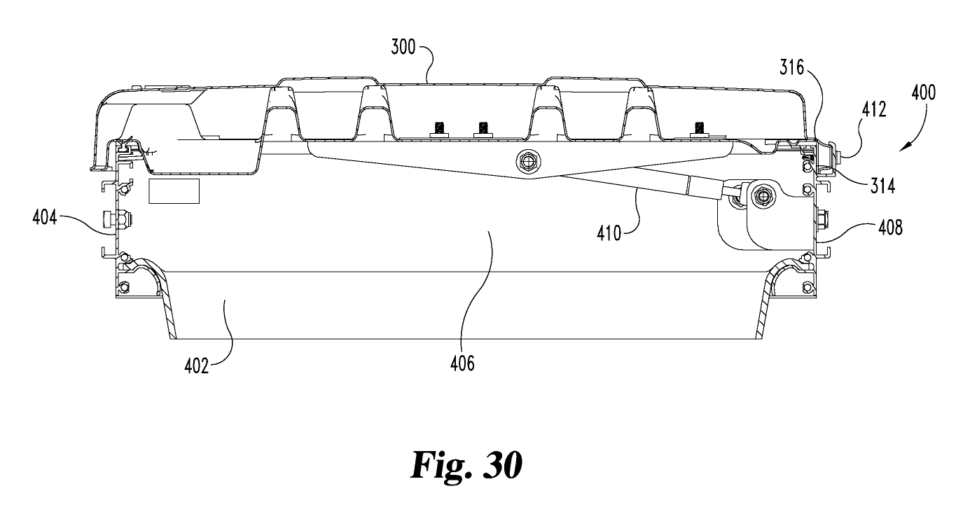

Referring now to FIGS. 26-30, box 400 is illustrated. Box 400 illustrates one application of lid 300 where lid 300 is coupled to an external structure to complete box 400. Box 400 includes lid 300, base 402, front panel 404, side panels 406, back panel 408 and spring 410. Back panel 408 also includes channel 112 constructed to receive tab 314 to couple lid 300 to back panel 408 and box 400. In the illustrated configuration, channel 412 receives tab 314 by sliding tab 314 longitudinally along the length of channel 412. A plurality of fasteners 414 optionally longitudinally secure tab 314 in channel 412 by passing through both channel 412 and tab 314. In the illustrated configuration, box 400 is configured as a truck bed toolbox mountable in a truck bed between bed side rails. However, box 400 could be configured as desired for a other applications.

Hinge 316 on lid 300 may have resiliency sufficient to support the weight of lid 300 when tab 314 is coupled to channel 412 to the extent that lid 300 does not close into contact with front panel 414 without an additional downward force applied to lid 300 (when oriented as shown in FIGS. 26-28). Spring 410 may optionally be added to bias lid 300 upwards to maintain lid 300 in an open position unless a closing force is applied to lid 300 sufficient to overcome spring 410 and the resiliency of hinge 316 to close lid 300 into contact with front panel 404. A latching or locking feature may be optionally included to maintain lid 300 in a closed position.

This disclosure serves to illustrate and describe the claimed invention to aid in the interpretation of the claims. However, this disclosure is not restrictive in character because not every embodiment covered by the claims is necessarily illustrated and described. All changes and modifications that come within the scope of the claims are desired to be protected, not just those embodiments explicitly described.

We claim:

1. A method of manufacturing a part, the method comprising:
heating a first plastic sheet above a glass transition temperature;
heating a second plastic sheet above the glass transition temperature;
molding the first plastic sheet with a first mold;
molding the second plastic sheet with a second mold; and
impressing the first plastic sheet and the second plastic sheet together between the first and second molds thereby forming the part and a living hinge on the part, wherein the living hinge is between approximately 0.028 inches and approximately 0.040 inches thick.

2. The method of claim 1 further comprising flexing the living hinge before the part has cooled to an ambient temperature.

3. The method of claim 1, wherein the part includes an elongated structure and a tab, wherein the living hinge separates the elongated structure and the tab and wherein the tab is constructed and arranged to be coupled to an external structure.

4. The method of claim 3 wherein the tab is constructed and arranged to slide within a channel.

5. The method of claim 3 wherein the tab is constructed and arranged to receive a plurality of mechanical fasteners to couple the tab to the external structure.

6. The method of claim 1, further comprising:
while compressing the first and second sheets, die cutting the first and second sheets on both ends of the living hinge.

7. The method of claim 1, wherein the elongated structure has a width and wherein the living hinge is continuous and extends across substantially the entire width.

8. The method of claim 1, wherein the living hinge is constructed and arranged to flex no more than ninety degrees.

9. The method of claim 3, wherein the living hinge has a resiliency sufficient to support the weight of the elongated structure with the weight of the elongated structure deflecting the living hinge less than 80 degrees.

10. An apparatus comprising:
a first sheet and a second sheet thermoformed together defining a lid structure, an attachment tab and a living hinge unitarily formed between the lid structure and the attachment tab, wherein the lid structure defines an inside ridge, an outside ridge and a groove between the inside and outside ridges, wherein the inside ridge and the groove are in the margin of the lid structure and substantially surround the lid structure, wherein the outside ridge is proximate to the periphery of the lid structure except along the living hinge and wherein the tab is constructed and arranged to be coupled to an external structure.

11. The apparatus of claim 10, wherein the living hinge is between approximately 0.028 inches and approximately 0.040 inches thick.

12. The apparatus of claim 10, wherein the tab is constructed and arranged to slide within and be received in a channel.

13. The apparatus of claim 10, wherein the tab is constructed and arranged to receive a plurality of mechanical fasteners to couple the tab to the external structure.

14. The apparatus of claim 10, wherein the lid structure has a width and wherein the living hinge is continuous and extends across substantially the entire width.

15. The apparatus of claim 10, wherein the living hinge is constructed and arranged to flex no more than 90 degrees.

16. The apparatus of claim 10, wherein the living hinge has a resiliency sufficient to support the weight of the lid structure with the weight of the lid structure deflecting the living hinge less than 80 degrees.

17. A lid comprising:
a first sheet and a second sheet thermoformed together defining a lid structure, an attachment tab and a living hinge unitarily formed between the lid structure and the attachment tab, wherein the attachment tab is constructed and arranged to slide within and be received in an extruded metal channel, wherein the living hinge is between approximately 0.028 inches and approximately 0.040 inches thick, wherein the living hinge is continuous and extends across substantially an entire width of the lid structure and wherein the living hinge has a resiliency sufficient to support the weight of the lid structure with the weight of the lid structure deflecting the living hinge less than 80 degrees.

18. The lid of claim 17, wherein the living hinge is constructed and arranged to flex no more than 90 degrees.

19. The lid of claim 17, wherein the living hinge is approximately 0.030 inches thick.
